(19) United States
(12) Patent Application Publication
(10) Pub. No.: US 2007/0214251 A1
(43) Pub. Date: Sep. 13, 2007

(54) Naming and accessing remote servers through security split reverse proxy

(76) Inventor: ZHONG LI, Windsor (CA)

Correspondence Address: ZHONG LI, 3880 GLENFIELD STREEET, WINDSOR, ON, N9C-2B2, US

(21) Appl. No.: 11/682,324

(22) Filed: Mar. 6, 2007

Related U.S. Application Data
(60) Provisional application No. 60/767,213, filed on Mar. 11, 2006.

(30) Foreign Application Priority Data
Mar. 7, 2006 (CA) 2539722

(51) Int. Cl. G06F 15/173

(52) U.S. Cl. 709/223

(57) ABSTRACT

Naming and accessing remote servers through a security split reverse proxy disclosed a virtual network system allowing internet clients locate a remote web server by URL and access the remote web server through a reverse proxy which split as two portions connected by at least one security connection. The virtual network system includes a Host Reverse Proxy server running on a Trusted Host Server and plurality of Remote Reverse Proxy servers each running on a remote private server; and at least one security connection is established between Host Reverse Proxy server and each Remote Reverse Proxy server using SSL or Security Tunnel.

### FIELDS OF THE INVENTION

The present invention relates methods and systems for accessing remote private servers through a security virtual network.

### BACKGROUND OF THE INVENTION

Today users who are away from their home or office have a need to be in communication with their private computers; also users need to share their information on their private computers and even want share information on their mobile device such as cell phone and PDA. Nokia Research Center is working on their Mobile Web Server project (http://research.nokia.com/research/projects/mobile-web-server/index.html).

In the future, no doubt we will live in a Smart House. Remote control and monitor the house will be our part of normal life. Today web applications are replacing legacy applications, most devices in the house will have web interface for monitor and control those devices. A control center will be necessary in the house. To access the control center through public network is needed.

Security is the most important issue for a private computer. Today most private computers stay behind various network security devices such as firewalls and NATs. Those devices may block all inbound accesses and only allow a few trusted URLs and protocols going out. A security and easy way is needed to access private computers.

Another issue is private computers don't have domain name on public network. Usually private computers only have dynamic internal Internet Protocols (IP) addresses, they don't have public IPs and domain names. How to locate a private computer on public network becomes a question.

The present innovation solves those issues.

### SUMMARY OF THE INVENTION

“A reverse proxy is a proxy server that is installed in the neighborhood of one or more servers. Typically, reverse proxies are utilized in front of web servers. All connections coming from the Internet addressed to one of the web servers are routed through the proxy server, which may either entirely deal with the request itself, or pass the request wholly or partially to the main web server.” and “security, encryption/SSL acceleration, load distribution, and caching static content” (http://en.wikipedia.org/wiki/Proxy_server) are reasons using reverse proxy.

“A split proxy is essentially a pair of proxies installed across two computers. Since they are effectively two parts of the same program, they can communicate with each other in a more efficient way than they can communicate with a more standard resource or tool such as a website or browser.” Google's Web Accelerator is an example of a split proxy.

Peter Sommerlad introduce three types of reverse proxy in his book “Reverse Proxy Patterns” (http://www.modsecurity.org/archive/ReverseProxy-book-1.pdf). “The Protection Reverse Proxy pattern shows how to protect your servers on the application protocol level at the network perimeter. An Integration Reverse Proxy allows integrating a collection of servers under a common entry point, thus hiding the network and host internals. The Front Door pattern gives guidance for single sign on and access control to a set of web applications.” The invention implements all three types proxy on one “Split Reverse Proxy”

The invention provides a virtual network system mapping a public domain name or sub-domain name to a remote private server and protecting the remote private server.

The virtual network system spit reverse proxy as two portions: one portion, HRP (Host Reverse Proxy) server, works as front door, protection reverse proxy and web accelerator; another portion, RRP (Remote Reverse Proxy) server, works as integration reverse proxy or a single agent. HRP and RRP connected by SSL or Security Tunnel, such as Socks SSL Tunnel, SSH Tunnel, HTTPS Tunnel and HTTP VPN Tunnel. (HTTP Tunnels Though Proxies by Daniel Alman, http://www.sans.org/rr/whitepapers/covert/1202.php)

### BRIEF DESCRIPTION OF THE DRAWINGS

FIG. 1 is a block diagram of the general structure of a possible example of embodiment of the method and systems of the invention.

FIG. 2 is a detailed block diagram of the Host Reverse Proxy server.

FIG. 3 is a detailed block diagram of the Remote Reverse Proxy server.

FIG. 4A is a flow diagram showing the operation of the Host Proxy Connector when connection is established.

FIG. 4B is a flow diagram showing the operation of the Remote Proxy Connector when connection is established.

FIG. 5A is a flow diagram showing the operation of the Host Reverse Proxy when request is processed.

FIG. 5B is a flow diagram showing the operation of the Host Reverse Proxy when response is processed.

FIG. 6A is a flow diagram showing the operation of the Remote Reverse Proxy when request is processed.

FIG. 6B is a flow diagram showing the operation of the Host Reverse Proxy when response is processed.

FIG. 7A is a sequence diagram showing a sample operation of the Host Reverse Proxy.

FIG. 7B is a sequence diagram showing a sample operation of the Remote Reverse Proxy.

### DETAILED DESCRIPTION OF EXEMPLARY EMBODIMENTS

The following description of the preferred embodiment(s) is merely exemplary in nature and is in no way intended to limit the invention, its application, or uses. The invention talks only about (HTTP) web servers, it applies to other protocols like FTP, IMAP, SMTP and SIP.

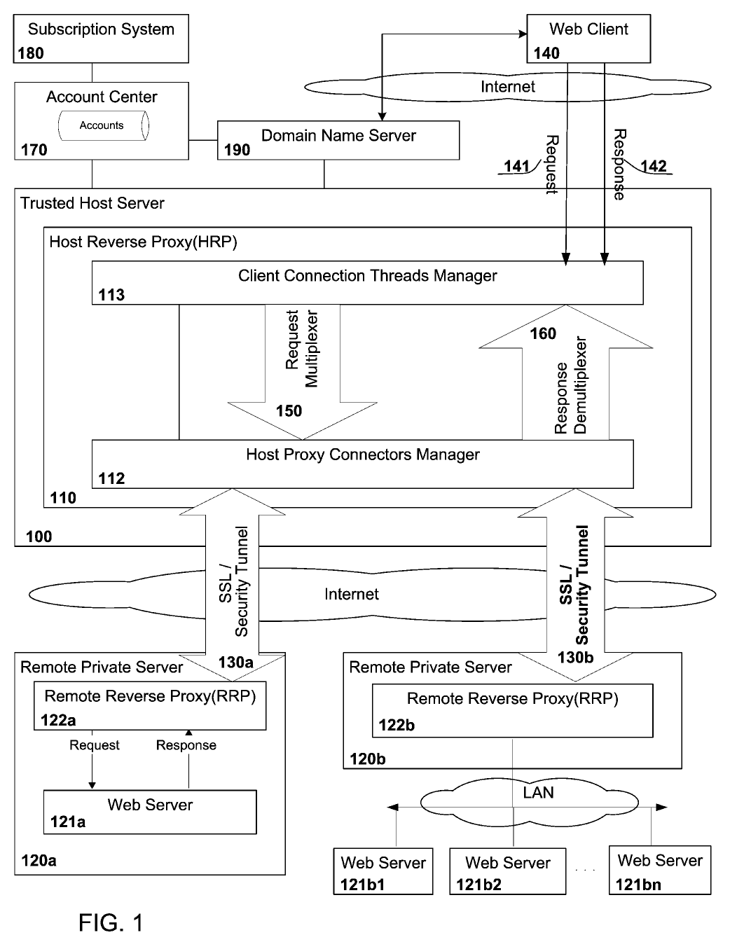

Referring now to FIG. 1, there is shown a Web Client 140 accesses a remote web server 121a, or plurality of web servers 121 sub. b1 to sub. bn. There are network security devices before the 140, the Trusted Host Server (THS) 100, the Account Center 170, the Subscription System 180, the Domain Name Server 190 and the Remote Private Server (RPS) 120a and 120b. Those network security devices are not showed on FIG. 1.

140 usually uses a web browser typing in a URL (Uniform Resource Locator) as an address, https://tv.joe.yytao.com/recorder as an example. A URL has a protocol, host name and file (page) name. In the example, https is protocol; tv.joe.yytao.com is host name (domain or sub-domain name); and recorder is file (page) name. The web browser discovers the host name's IP address on public network through 190. The host name maps to the IP address, which the host name virtually hosts on 100. In the example, yytao.com is 100, tv.joe.yytao.com has same IP address as yytao.com's, such as 82.165.134.5.

100 can be a computer or a computer cluster, here just said a Trusted Host Server system. The host name with account information is saved on 170 and is subscribed through 180 that details are not disclosed on the invention.

170 is well-protected security server with a database, a LDAP or other Identity and Directory Services system.

An account table having account name and security configurations, such as “account name”, “hashed password”, “accepted IPs”, “maximum connections number” and etc. In the example, Joe is account name; a private hashed password saved in his account; and “ip=82.12.10.0; mask=255.255.254.0” as his legal IP scope.

A host table saves all host names and maps each host names to an account name, such as joe.yytao.com->“Joe”, tv.joe.yytao.com->“Joe”, safebox.joe.yytao.com->“Joe”. One account can have a plurality of host names.

A host configuration table saves settings for each host name. Configuration table has fields “single sign on enable”, “anonymous access allowed”, “protocols accepted”, “content cacheable”, “compress enable”, “browsers accepted”, “IPs blocked”, “maximum concurrent requests allowed”, “maximum content size”, “maximum headers size”, “maximum URL size”, “maximum request parameter size” and others.

A client table saves clients' information, such as “client name”, “client password”, “client address” and etc.

A client-host table maps each client to a host name. One client can map to a plurality of host names. If anonymous access is not allowed, a web client has to be a member of the host name.

The Host Reverse Proxy (HRP) 110 system as a web (http) server runs on 100. 110 is a partial reverse proxy. 110 has four components: the Client Connection Threads Manager 113, the Host Proxy Connectors Manager 112, the Request Multiplexer 150 and the Response Demultiplexer 160.

113 works as front door, protection reverse proxy and web accelerator.

If host names of an account as a group set as single sign on enable, 113 enables Single Sign On (SSO) for the group; 140 has to be authorized by SSO.

113 scans all requests and responses, protects both web clients and remote web servers.

113 caches web contents of remote web servers if “content cacheable” is set; and compresses content between web clients and remote web servers if “compress enable” is set. 113 accelerates performance by caching and compressing. Also 113 can equip SSL acceleration hardware improving the performance of SSL request.

112 establishes security persistent connections 130a with RPS 120a and 130b with RPS 120b. The connection can be established by SSL direct connection or others security connection, such as a Socks SSL Tunnel. 130a and 130b allow multiple connections established for each RPS for improving performance. The trusted certification of 100 and the authentication of RPS are required for authorization.

120a shows one case of remote private server, the Remote Reverse Proxy (RRP) 122a system and the Web Server 121 a run on the same device, such as a computer, a mobile device or other electronic device. 122a runs as an agent, forwards request from 110 to the 121a and return response from 121a to 110.

120b shows another case of remote private server, 122b runs as a single system on 120b. 122b accesses 121 sub. b1 to bn through Local Area Network (LAN). Under this case, 122b works as integration reverse proxy, it maps URL to target web server based on mapping rules or policies.

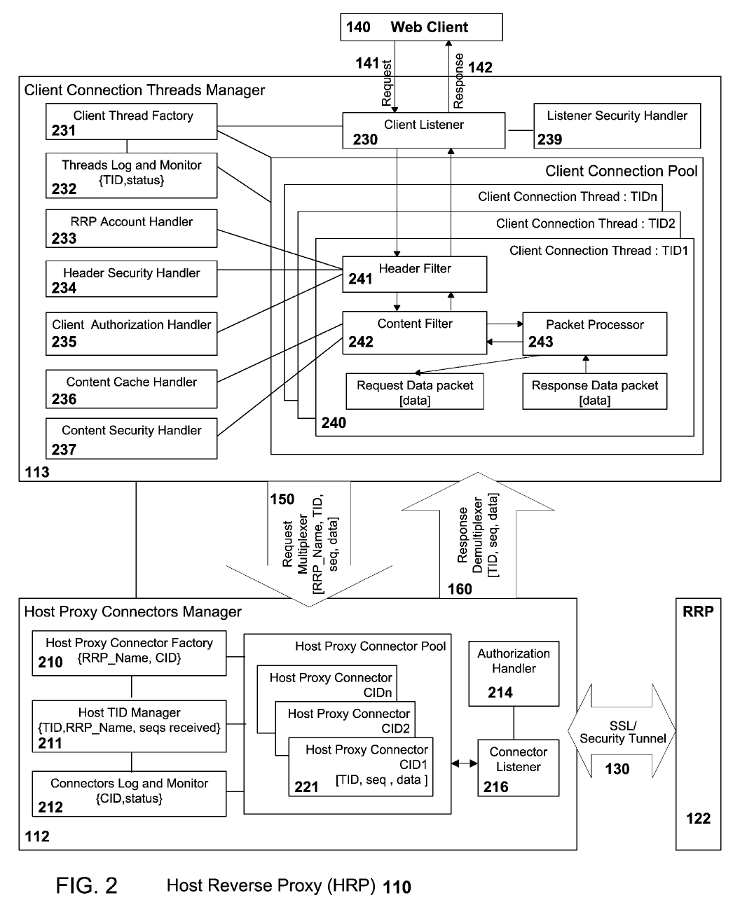

Referring now to FIG. 2, before 113 accept any request from 140, a security persistent connection 130 is established; otherwise a cached content or an error as response is sent back to 140.

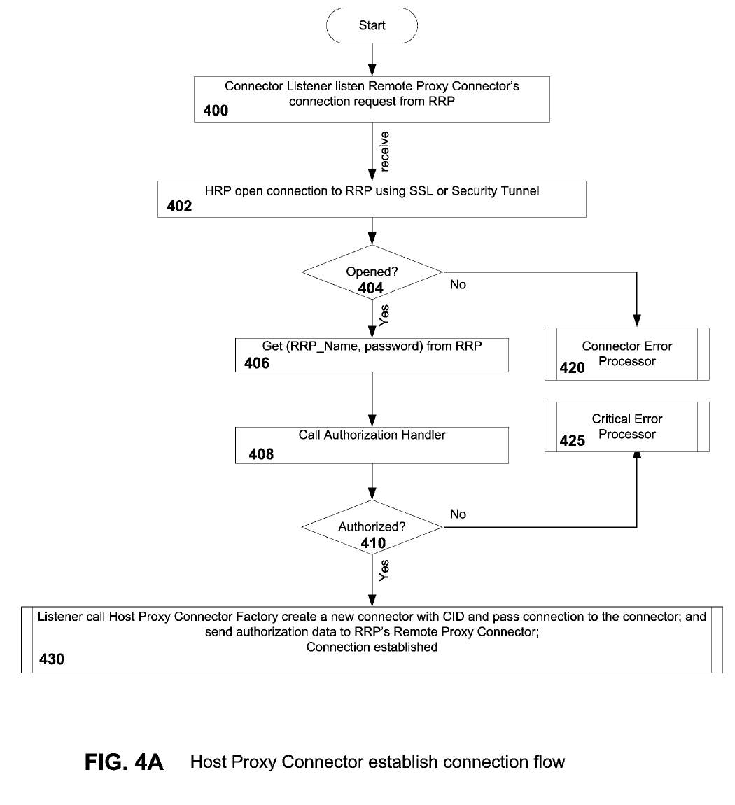

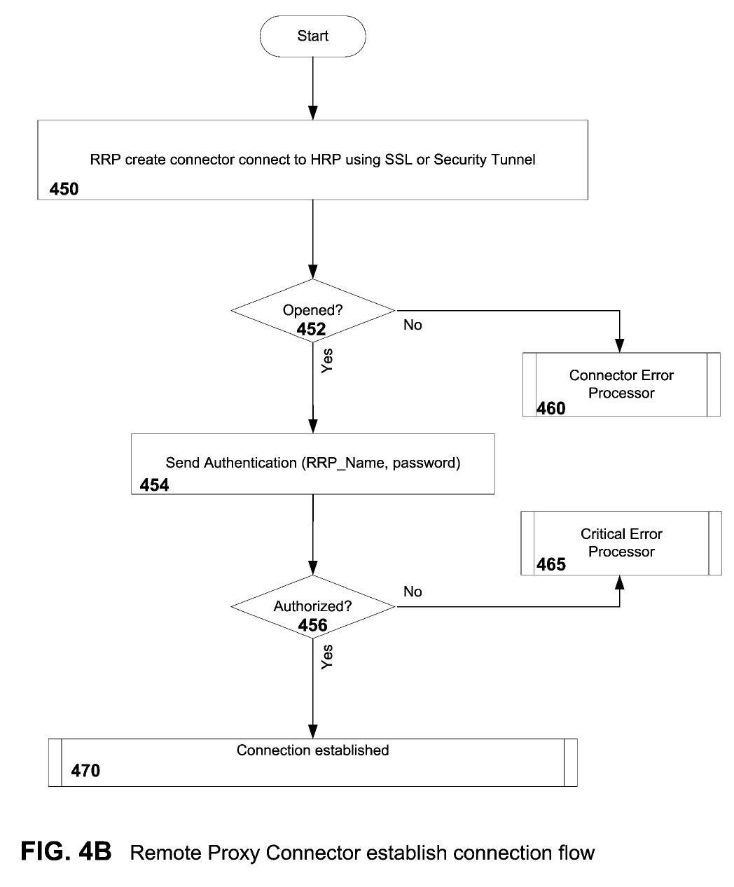

FIG. 4A shows the flow of a Host Proxy Connector (HPC) 221 (FIG. 2) created. In the sample, the inventor only illustrates a simple authentication and authorization method based on username and password. There is no way to limit use any other authentication and authorization method.

The Connector Listener 216 (FIG. 2) listens all connection requests from RRP 122 in block 400. When 216 accepts a connection request, 216 opens a SSL or Security Tunnel connection in block 402. The decision block 404 will check the connection is opened or not based on connection method used. Example SSL negotiation may be failed. If a connection can't be opened, block 420 handles error and writes a log. After the connection opened, 216 is waiting the authentication of 122. 216 gets username and password; and calls Authorization Handler 214 (FIG. 2). 214 retrieves account information from 170. The decision block 410 checks if IP address matches “accepted IPs” and current connections number equals “maximum connections number”; and compares account name and hashed password. If 410 tests result is failure, 410 can't authorize the connection, 425 handles error, logs information and sends alert to administration; if 410 passes the test, 410 authorizes the connection. In block 430, 216 calls Host Proxy Connector Factory 210 (FIG. 2) to create a new Host Proxy Connector 221 (FIG. 2) with new connection identification (CID) assigned; forwards the connection to 221; and send authorization confirmation to 122. 130 is established.

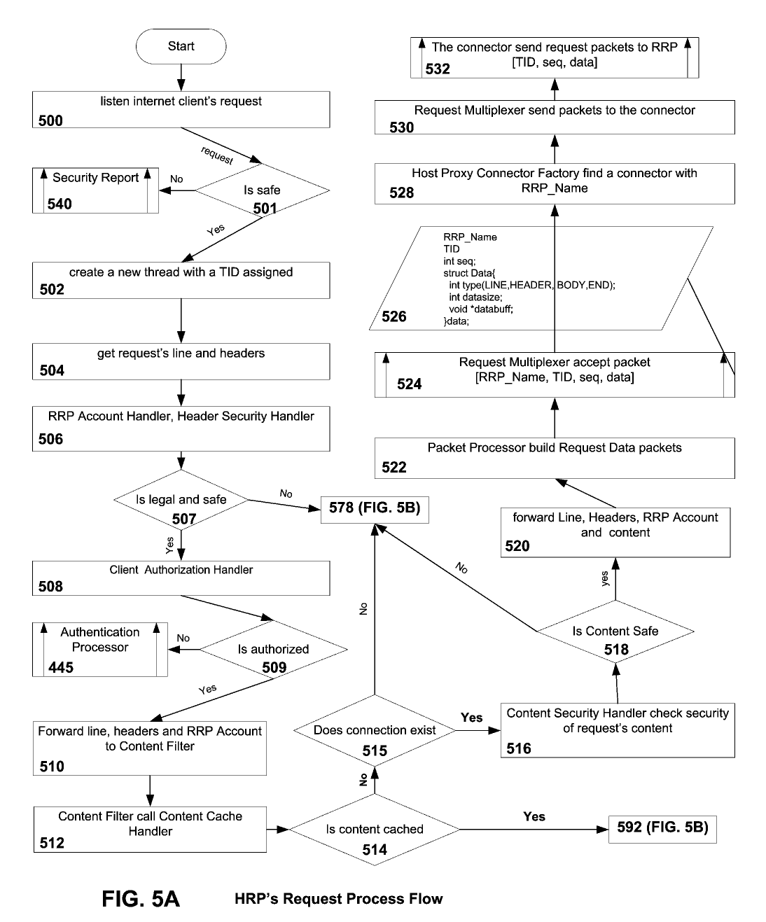

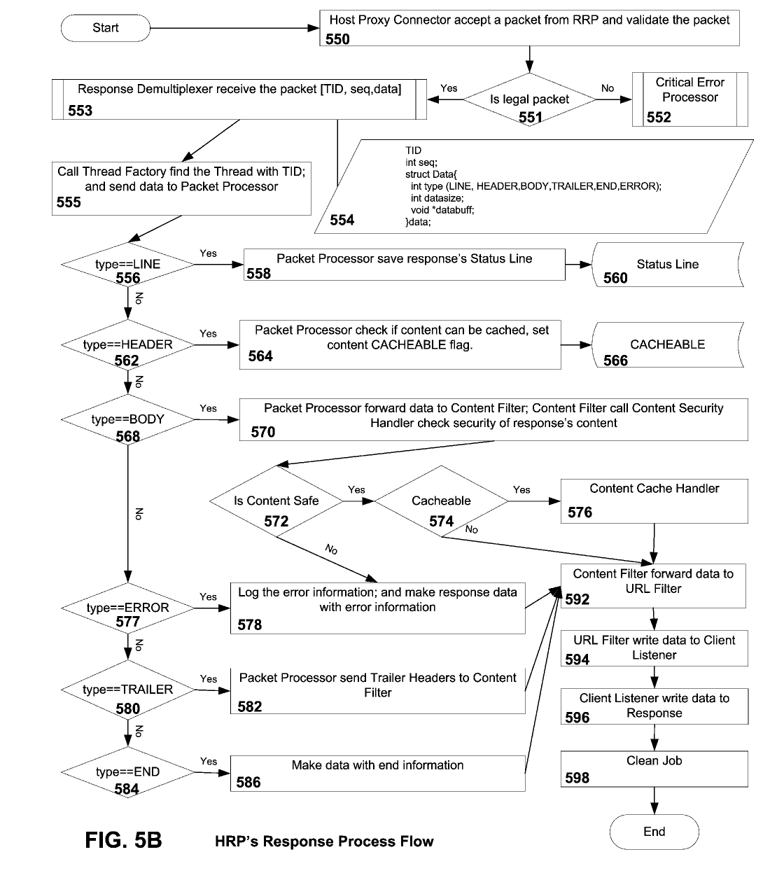

FIG. 5A shows the flow of 110 processing a client request.

The Client Listener 230 (FIG. 2) listens all client requests through Internet. 230 receives 141 in block 500. 230 calls Listener Security Handler 239 (FIG. 2) in decision block 501. 239 checks securities, such as IP blacklist, denial of service defense strategy, intrusion detection and etc. If the client's IP is blocked or client is an intruder, 239 makes logs and/or sends red alert in block 540. If the client is safe, in block 502, 230 calls Client Thread Factory 231 to create a new Client Connection Thread 240 with new thread identification (TID) assigned; and forwards 141 to 240.

240 reads line and headers information from 141; and calls Request Filter 241 (FIG. 2) in block 504. 241 calls RRP Account Handler 233 (FIG. 2) and Request Security Handler 234 in block 506.

233 retrieves account information from 170 based on host name. If the account of the host name exist and is good status, passes account information to 234 and add “legal” into status; otherwise goes to decision block 507 with illegal status.

234 tests with fields, “protocols accepted”, “browsers accepted”, “IPs blocked”, “maximum concurrent requests allowed”, “maximum request parameter size” and “maximum URL size”. If any test fails, goes to decision block 507 with unsafe status, otherwise add “safe” into status. If statuses are “legal” and “safe” in 507, goes to block 508; otherwise goes to 578 (FIG. 5B) for response with error messages.

241 calls the Client Authorization Handler 235 processing authorization in block 508. If “anonymous access allowed” is set, 235 sets status as “authorized” and goes to decision block 509; otherwise, the inventor shows two cases as sample.

Case one, “single sign on enable” is set, 235 validates 140 token. If the token is valid, 235 sets status as authorized; otherwise sets status as unauthorized.

Case two, “single sign on enable” isn't set, 241 uses HTTP Authentication method as default. 241 checks “Authorization” header, if “Authorization” header exists, 235 retrieves client information from client table and validates the header. If the client is valid, 235 sets status as authorized; otherwise sets status as unauthorized.

If status is unauthorized in decision block 509, goes to block 545 for authentication process; otherwise goes to block 510. The inventor doesn't disclose any authentication method in this invention. Kerberos protocol, http://web.mit.edu/kerberos/, can be used as single sign on implementation; and Basic and Digest Access Authentication, http://rfc.net/rfc2617.html, can be used as HTTP Authentication implementation.

241 forwards request line, headers and account information to the Content Filter 242 (FIG. 2) in block 510. If “content cacheable” is set, 242 calls Content Cache Handler 236 (FIG. 2) in block 512; otherwise 242 sets status as “no content cached”. 236 checks content repository, compares URL and checks expiration. If content is cached and valid, 236 sets status as “content cached”; otherwise sets status as “no content cached”.

If status is “content cached” in decision block 514, goes to 592 (FIG. 5B) for response phase; otherwise goes to 515. If there is no 130 exist for the request in decision block 515, goes to 578; otherwise goes to 516. 242 call the Content Security Handler 237 (FIG. 2) in block 516. 237 provides virus scanning and content type filtering, such as blocking execution code and CGI code. If 237 find unsafe content in decision block 518, goes to 578; otherwise goes to block 520. 242 forwards account information, request line, headers and content to Packet Processor 243 (FIG. 2) in block 520. In block 522, 243 builds a plurality of sequencing request data packets with one of type LINE, HEADER, BODY or END. If the content size is too large, the content is split as sequence of packets with BODY type data.

150 waits request data packets from all client connection threads in block 524. When 150 accepts a request data packet, puts a new packet in a queue. The new packet wraps the request packet with account name, client connection thread identification, packet sequence number and data. The structure of the new packet is shown in 526. In block 528, 150 calls Host Proxy Connector Factory 210 (FIG. 2) to find one of connector of the account. The connector 221 accepts a request packet including connection thread identification, packet sequence number and data from 150 and sends the request packet out to 122 through 130. So far, 110 ends 141 processing.

FIG. 5B shows the flow of 110 processing a response.

221 accepts a response packet including connection thread identification, packet sequence number and data from 122 in block 550; reads TID and sequence number in the packet and calls the Host TID Manager 211 (FIG. 2). 211 checks duplication of sequence number. If the sequence number is duplicate, sets the packet as “illegal”. 221 also checks the size of the packet, if too large, sets the packet as “illegal”.

If the response packet is illegal packet in decision block 551, 221 calls the critical error processor in block 552. The critical error processor logs the error and sends alert to administrator. If the response packet passes validation of 221; 221 sends the response packet to 160.

160 waits response packets from all host proxy connectors. In block 553, when 160 accepts a response packet from 221, 160 decode the response packet, put the response packet in a queue. If the packet is first packet or all pre-packets of the TID have been accepted, calls 231 to find the thread with identification is TID in block 555, and sends a response data packet to 243. 243 decodes the response data packet and checks the type of data.

If the type is LINE in decision block 556, 243 saves the data as the status line (560) of the response in block 558; otherwise goes decision block 562.

If the type is HEADER. 243 checks if the content of the response is cacheable and “content cacheable” is set in block 564. If the content is cacheable, 243 saves CACHEABLE (566) flag.

If the type is BODY in decision block 568, 243 forwards data to 242 in block 570. 242 calls 237 to check the safety of the content in decision block 572, if the content is not safe, goes to block 578; otherwise goes to decision block 574. If the flag of CACHEABLE is set, 242 calls 236 to cache the response in block 576. After this, goes to block 592.

If the type is ERROR in decision block 577, 243 logs error information and builds data as response based on different error in block 578. 243 sends the data to 242, and goes to block 592.

If the type is TRAILER in decision block 580, 243 forwards trailer headers to 242 in block 582, and goes to block 592.

If the type is END in decision block 584, 243 sends a data with end information to 242, and goes to block 592.

In block 592, 242 gets any type of data, if “compress enable” is set, 242 compresses the data if necessary. 242 forwards data to 241. 241 rewrites headers and trailer headers if necessary in block 594, and sends data to 230. 230 writes response 142 to 140; and goes to 598. 230 calls 231 to destroy the client connection thread with identification TID. 231 does clean job. So far, 110 ends 142 processing.

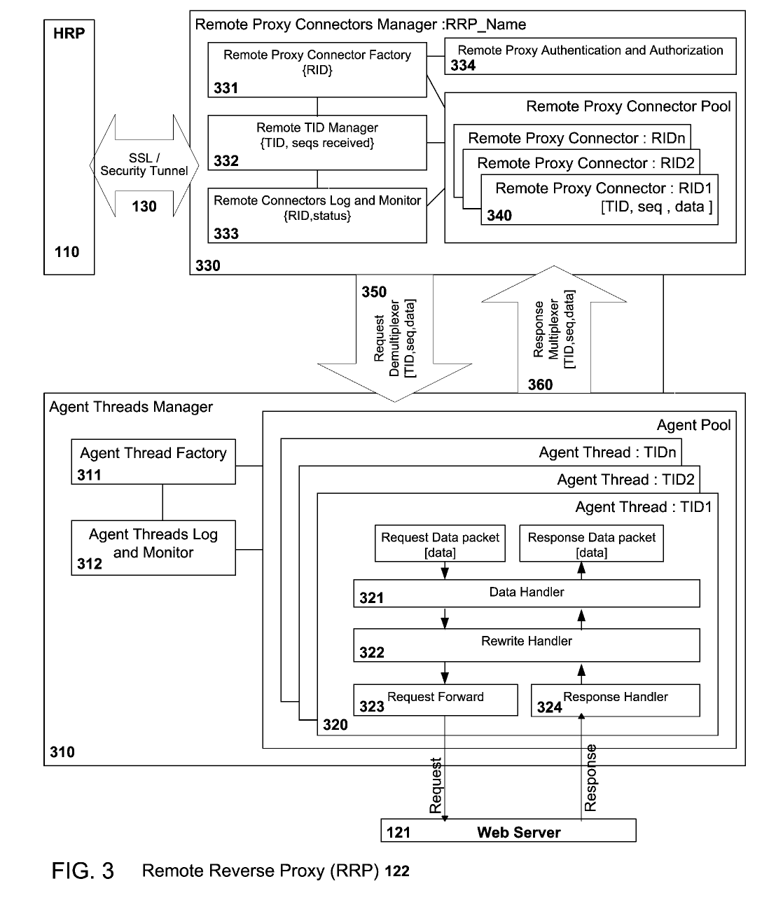

Referring now to FIG. 3, before 122 accepts any request from 110 or sends any response to 110, at least one security persistent connection 130 must be established.

FIG. 4B shows the flow of a Remote Proxy Connector (RPC) 340 (FIG. 3) created. Steps in FIG. 4B map steps in FIG. 4A.

122 calls the Remote Proxy Connector Factory 331 (FIG. 4B) to create the Remote Proxy Connector 340 and assigns a RID as identification in block 450. 340 opens a SSL or Security Tunnel connection to the trusted host server. 340 calls 334 to validate the host server by the certification of the trusted host server. If a connection is opened successfully in decision block 452, goes to block 454; otherwise goes to block 460 for error processing. After the connection is opened, 340 calls 334 get a authentication with account name, RRP_Name, and hashed password. 340 sends the authentication to 110. 340 waits authorization information from 110 in decision block 456. If 340 receives authorization information and the connection is authorized, goes to block 470 and the connection 130 is established; otherwise logs the error and sends alert in block 465.

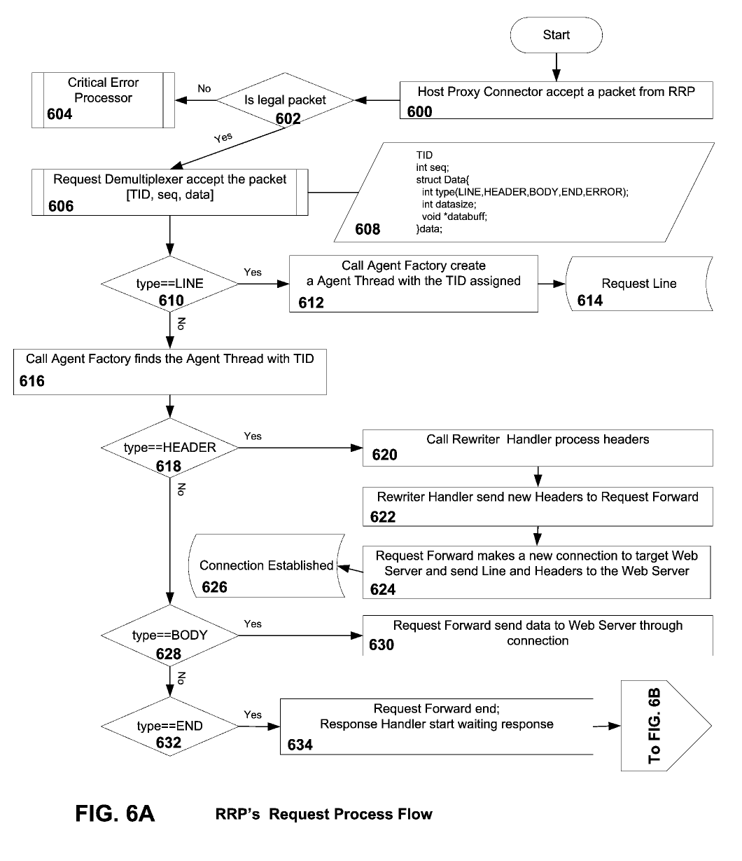

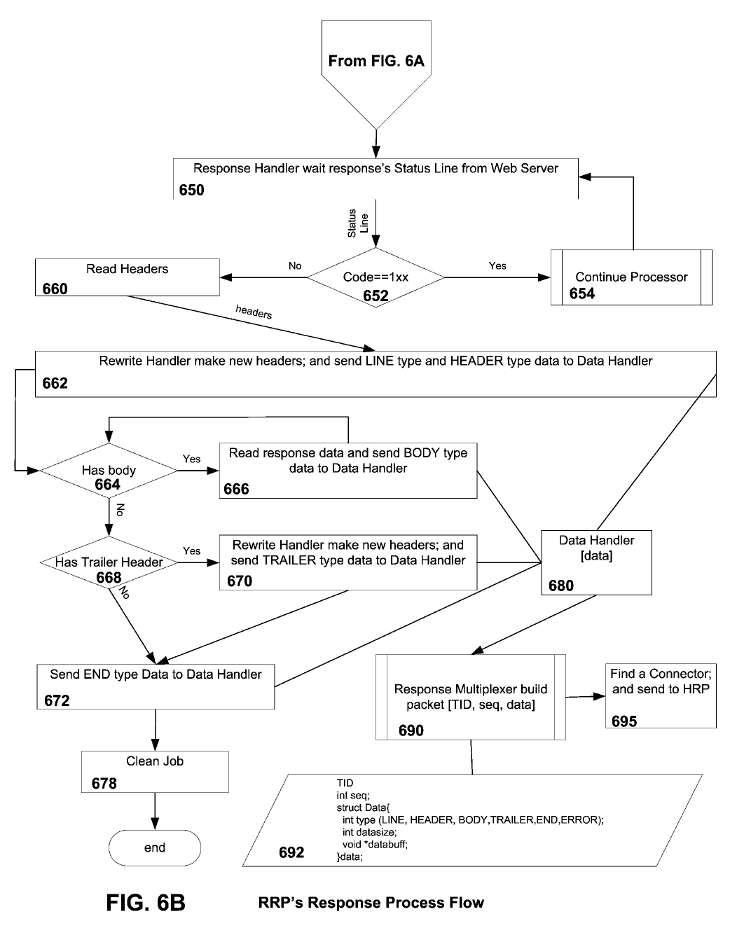

FIG. 6A shows the flow of 122 processing a client request.

110 sends a request packet to 340 through 130 in block 532 (FIG. 5A). 340 accepts the request packet in block 600. 340 calls the Remote TID Manager 332 (FIG. 3) to check TID and sequence number. If the request packet sequence number is duplicated, 332 sets the packet as illegal packet. 340 also check size of the packet. It the size of the request packet is too large, sets the packet as illegal packet. If the request packet is illegal packet in decision block 602, goes to block 604 for critical error processing; otherwise sends the request packet to the Request Demultiplexer 350 (FIG. 3).

350 accepts the request packet in block 606. The structure of the packet shows in block 608. 350 decodes the request packet and puts the request packet in a queue. If the request packet is first packet or all pre-packets of the TID have been accepted, 350 checks the type of data.

If the type is LINE in decision block 610, 350 calls the Agent Thread Factory 311 (FIG. 3) in block 612.

311 creates a new agent thread and assigned the TID as the identification of the Agent Thread 320 (FIG. 3). 350 forwards the data to 320. 320 saves the data as request line in block 614.

If the type is not LINE, 350 calls 311 to find the 320 with identification as TID in block 616 and forwards the data to the Data Handler 321.

321 checks the type of the data.

If the type is HEADER in decision block 618, 321 calls the Rewrite Handler 322 (FIG. 3) to process headers in block 620. 322 sends new headers to the Request Forward 323 (FIG. 3) in block 622. 323 maps request line, new headers to a web server based on mapping rules or policies. 323 makes a new connection to the web server 121 (FIG. 3) in block 624, and sends request line and headers to 121 as request. The connection is established between 320 and 121. 320 keeps the connection in block 626.

If the type is BODY in decision block 628, 323 sends the data to 121 through the connection 626 in block 630.

If the type is END in decision block 632, 320 ends request phase and start waiting response in block 634 and goes to block 650 in FIG. 6B.

FIG. 6B shows the flow of 122 processing a response.

320 waits the status line of 121 through the connection. When the Response Handler 324 (FIG. 3) accepts the status line in block 650, checks the status code.

If the code is 1xx in decision block 652, goes to block 654 to process continue; otherwise 324 reads headers in block 660.

324 sends headers to 322. In block 662, 322 rewrite headers and sends LINE type data and HEADER type data to 321.

If the response has body data in decision block 664, 324 reads the body of the response in block 666 and sends BODY type data to 321 until no body data in the response.

If the response has trailer headers in decision block 668, 324 reads trailers and sends to 322 in block 670. 322 rewrite trailer heads as new TRAILER type data to 321.

In block 680, 321 builds a plurality of sequencing response data packets and sends the response data packets to the Response Multiplexer 360 (FIG. 3).

There is no more useful data in the response. 320 sends END type data to 321 in block 672. 320 calls 311 to destroy 320, 311 does clean job in block 678.

360 builds a response packet with TID, sequence number and data in block 690. The response packet structure is showed in block 692. 360 calls 331 to find a 340 and sends the packet to 340. 340 sends the response packet to 110 through 130. So far, 122 processes the response.

The system has multiple monitoring and logging methods.

232 (FIG. 2) monitors and logs requests, responses and the status of 240.

212 (FIG. 2) monitors and logs the connection requests of 122, the status of 221 and packets through 130.

333 (FIG. 3) monitors and logs the connection requests of 122, the status of 340 and packets through 130.

312 (FIG. 3) monitors and logs the status of 320, requests to 121 and responses from 121.

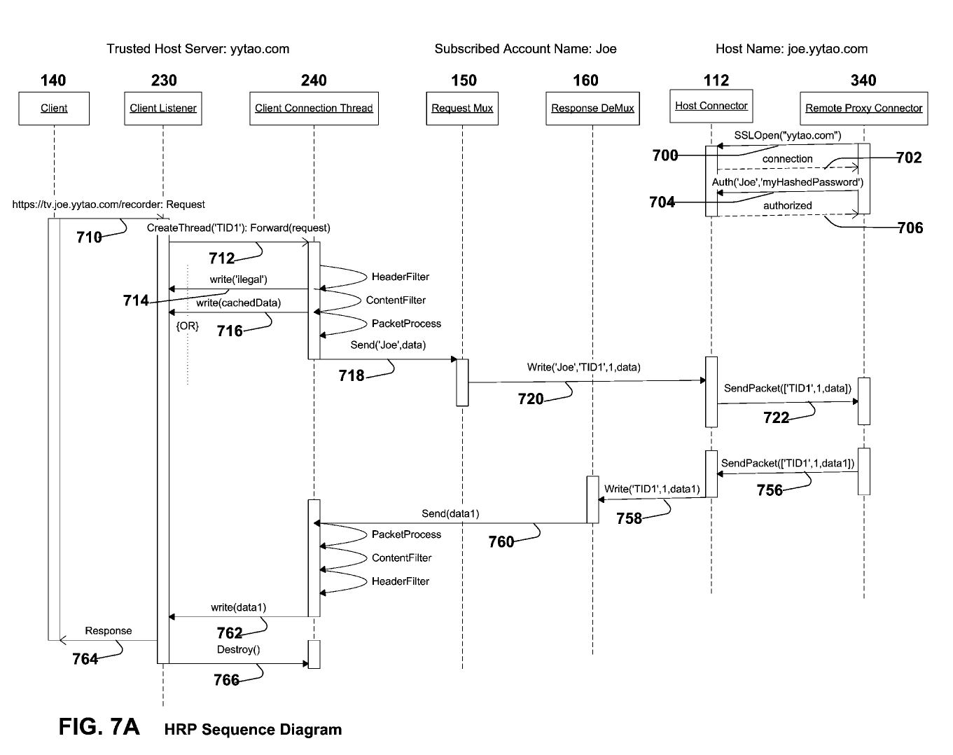

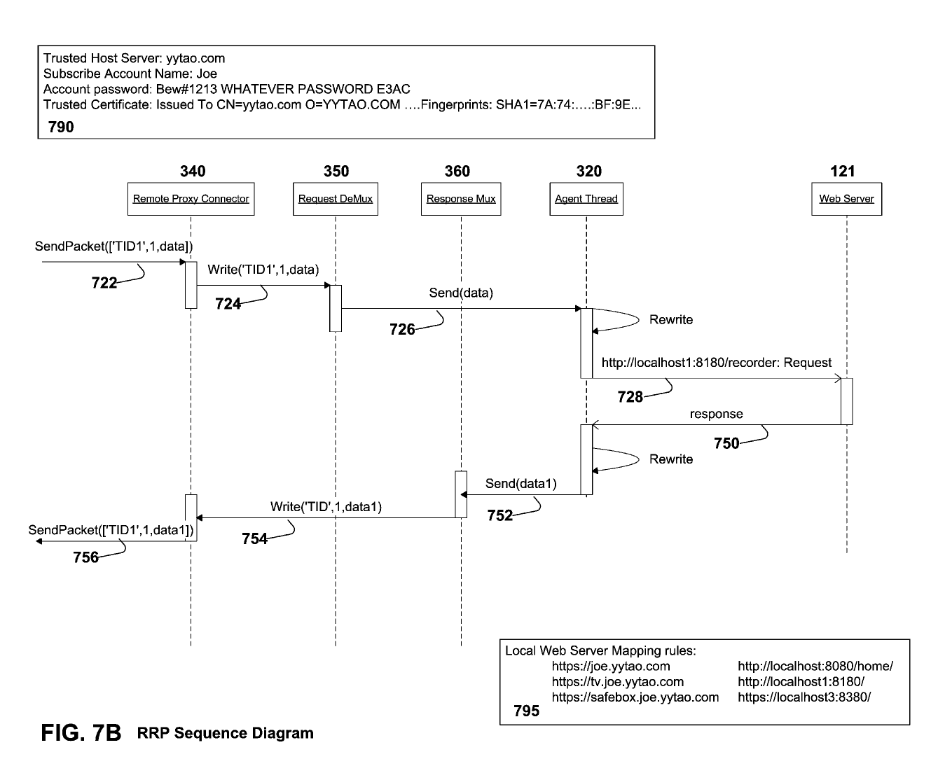

Referring now to FIG. 7A and FIG. 7B are sequence diagrams showing a simple example. A client wants to access Joe's home web application of TV recorder. Joe has subscribed an account, Joe, on a trusted server yytao.com. The account uses a sub-domain joe.yytao.com hosting on yytao.com as Joe's root account. Also Joe has hosts of tv.joe.yytao.com and safebox.joe.yytao.com. Joe's account information is saved on 170.

Joe installed RRP server on Joe's home network. The RRP server can access Joe's local web servers, http://localhost:8080, http://localhost1:8180, and https://localhost3:8380. Joe also installed the certification of yytao.com and set mapping rules 795 (FIG. 7B). Joe starts RRP server with trusted host server name, account name, and password showing in 790 (FIG. 7B).

RRP starts initial connection processing. The step 700 (FIG. 7A) shows 340 sending a connection request using SSL direct connect to 112. 112 creates a connection 702. At step 704, 340 sends authentication to 112; and 112 sends 726 back to 340. The security persistent connection 130 is established.

A client 140 sends http request, https://tv.joe.yytao.com/recorder, to client listener 230 (step 710). 230 creates a thread 240 with TIDI, and forwards the request to 240 (step 712). 240 checks URL; if the URL or content is unsafe, sends error information data to 230 (step 714). If the request is cacheable and there is content cached, 240 sends content cached to 230 (step 716); otherwise send data with account name, “Joe”, to 150 (step 718). 150 multiplexes data packets with TID and sequence number; sends the packets to 112 having a connection with 340 (step 720). 112 sends a packet to 340 (step 722).

340 writes a data packet to 350 (step 724). 350 demultiplexes the data packet and sends data to 320 (step 726). According the mapping rules, 320 rewrites request line and headers in the data; forwards the request to 121 (step 728).

121 returns a response to 320 (step 750). 320 rewrites the response and sends data to 360 (step 752). 360 multiplexes the data with TID and sequence number; writes the data packet to 340 (step 754). 340 sends packet to 112 (step 756). 112 writes the data packet to 160 (step 758). 160 demultiplexes the data packet and sends the data to 240 (step 760). 240 processes the data, checks security and caches contents if allowed. 240 writes the data as a response to 230 (step 762). 230 sends the response to 140 (step 766) and 240 is destroyed (step 768).

The embodiments of the invention in which an exclusive property or privilege is claimed are defined as follows:

1. A split reverse proxy system comprising: (a) a host reverse proxy server having an address known by clients; (b) a plurality of remote reverse proxy servers each communicating with at least one web server; (c) at least one persistent connection is established between the host reverse proxy server and each remote reverse proxy server.

2. The system of claim 1 wherein the host reverse proxy server further comprises (a) a client connection threads manager accepting and processing a plurality of requests, and processing and sending a plurality of responses; (b) a host proxy connectors manager sending a plurality of request packets and accepting a plurality of response packets through each persistent connection; (c) a request multiplexer multiplexing a plurality of request data packets; and (d) a response demultiplexer demultiplexing a plurality of response packets.

3. The system of claim 2 wherein the client connection threads manager further comprises (a) a client listener receiving the requests of clients and sending the responses to the clients; (b) a plurality of client connection threads each mapping to one of the requests, accepting and analyzing the request, mapping the request to one of the remote reverse proxy, encoding the client request as a plurality of sequencing request data packets, sending the sequencing request data packets to the request multiplexer, accepting a plurality of sequencing response data packets from the response demultiplexer, decoding the sequencing response data packets to a response, analyzing the response and writing to the client listener.

4. The system of claim 2 wherein the host proxy connectors manager further comprises (a) a connector listener receiving a plurality of connection requests from the remote reverse proxy servers, establishing one persistent connection for each connection request, creating a host proxy connector, forwarding the persistent connection to the host proxy connector; (b) a plurality of host proxy connectors each accepting a plurality of request packets from the request multiplexer, sending the request packets to the persistent connection; and receiving a plurality of response packets through the persistent connection, and sending the response packets to the response demultiplexer.

5. The system of claim 2 wherein the request multiplexer multiplexes a plurality of client request data packets so as to support a plurality of simultaneous client requests for each remote reverse proxy.

6. The system of claim 2 wherein the response demultiplexer demultiplexes a plurality of response packets so as to support a plurality of simultaneous web server responses for each remote reverse proxy.

7. The system of claim 1 wherein the remote reverse proxy servers each further comprises (a) a remote proxy connectors manager accepting a plurality of request packets and sending a plurality of response packets through each persistent connection; (b) an agent threads manager processing a plurality of requests, forwarding each request to a web server, accepting a plurality of responses from web servers, processing each response; (c) a request demultiplexer demultiplexing a plurality of request packets; and (d) a response multiplex multiplexing a plurality of response data packets.

8. The system of claim 7 wherein the remote proxy connectors manager has a plurality of remote proxy connectors each sending a connection request to the host reverse proxy sever, establishing a persistence connection with the host reverse proxy server, receiving a plurality of request packets and sending a plurality of response packets through the persistence connection.

9. The system of claim 7 wherein the an agent threads manager has a plurality of agent threads each receiving a plurality of sequencing request data packets from the request demultiplexer, analyzing and decoding the sequencing request data packets as a request, mapping the request to a web server, forwarding the request to the web server, accepting a response from the web server, coding the response as a plurality of sequencing response data packets, sending the sequencing response data packets to the response multiplexer.

10. The system of claim 7 wherein the request demultiplexer demultiplexes a plurality of request packets so as to support a plurality of simultaneous requests for each web server.

11. The system of claim 7 wherein the response multiplexer multiplexes a plurality of response data packets so as to support a plurality of simultaneous responses for each web server.

12. The system of claim 1 wherein one persistent connection is established between the host reverse proxy and the remote reverse proxy server. The host reverse proxy listens connection requests and the remote reverse proxy server initials to send a connection request.

13. The system of claim 1 wherein one persistent connection is established using a Transfer Control Protocol (TCP) direct connection.

14. The system of claim 1 wherein one persistent connection is established using a SOCKS proxy connection.

15. The system of claim 1 wherein one persistent connection is established using a tunnel connection.

16. A virtual network system through a security split reverse proxy comprising: (a) a Domain Name Server (DNS) having all the entries of virtual hosting host names; (b) an account center having all the account information of remote private servers; (c) a host reverse proxy server having an address known by clients; (d) a plurality of remote reverse proxy servers each communicating with at least one web server; (e) at least one security persistent connection is established between the host reverse proxy server and each remote reverse proxy server.

17. The system of claim 16 wherein the account center is a database server including (a) an account table having account name and security configuration; (b) a host table having all host names and mapping each host names to an account name; (c) a host configuration table having the configurations of each host names; (d) a client table having clients information; and (e) a client-host table mapping each client to a host name.

18. The system of claim 16 wherein the host reverse proxy server further comprises (a) a client connection threads manager accepting and processing a plurality of requests, and processing and sending a plurality of responses; (b) a host proxy connectors manager sending a plurality of request packets and accepting a plurality of response packets through each security persistent connection; (c) a request multiplexer multiplexing a plurality of request data packets; and (d) a response demultiplexer demultiplexing a plurality of response packets.

19. The system of claim 18 wherein the client connection threads manager further comprises (a) a client listener receiving the requests of clients and sending the responses to the clients; (b) a listener security handler implementing a detection method for validating and detecting the requests; (c) a account handler retrieving account information from the account center for each request and mapping the request to an account; (d) a header security handler implementing a detection method for detecting and validating headers of the request based on the account information; (e) a client authorization handler implementing a authentication and authorization method for validating clients; (f) a content cache handler implementing a caching method for caching the response contents of web servers; (g) a content security handler implementing a detection method for scanning both the request contents of clients and the response contents of web servers; (h) a plurality of client connection threads each mapping to one of the requests, accepting and analyzing the request, mapping the request to one of the remote reverse proxy, encoding the client request as a plurality of sequencing request data packets, sending the sequencing request data packets to the request multiplexer, accepting a plurality of sequencing response data packets from the response demultiplexer, decoding the sequencing response data packets to a response, analyzing the response and writing to the client listener.

20. The system of claim 19 wherein the client connection threads each further comprises (a) a header filter processing the headers of both the requests and responses by calling the account handler, header security handler and client authorization handler; (b) a content filter processing the contents of both the requests and responses by calling the content cache handler and the content security handler; and (c) a packet processor processing a request as a plurality of sequencing request data packets and converting a plurality of sequencing response data packets as a response.

21. The system of claim 18 wherein the host proxy connectors manager further comprises (a) a connector listener receiving a plurality of connection requests from the remote reverse proxy servers, establishing one security persistent connection for each connection request, creating a host proxy connector, and forwarding the persistent connection to the host proxy connector; (b) a authorization handler implementing a authentication and authorization method for validation each connection requests of remote reverse proxy servers; (c) a plurality of host proxy connectors each accepting a plurality of request packets from the request multiplexer, sending the request packets to the security persistent connection; and receiving a plurality of response packets through the security persistent connection, and sending the response packets to the response demultiplexer.

22. The system of claim 18 wherein the request multiplexer multiplexes a plurality of client request data packets so as to support a plurality of simultaneous client requests for each remote reverse proxy.

23. The system of claim 18 wherein the response demultiplexer demultiplexes a plurality of server response packets so as to support a plurality of simultaneous web server responses for each remote reverse proxy.

24. The system of claim 16 wherein the remote reverse proxy servers each further comprises (a) a remote proxy connectors manager accepting a plurality of request packets and sending a plurality of response packets through each security persistent connection; (b) an agent threads manager processing a plurality of requests and forwarding each request to a web server; and accepting a plurality of responses from web servers and processing each responses; (c) a request demultiplexer demultiplexing a plurality of request packets; and (d) a response multiplex multiplexing a plurality of response data packets.

25. The system of claim 24 wherein the remote proxy connectors manager has a (a) a authentication and authorization method having account information of the host reverse proxy server and the remote reverse proxy server, and validating each security persistent connection; and (b) a plurality of remote proxy connectors each sending a connection request to the host reverse proxy sever, establishing a security persistence connection with the host reverse proxy server, receiving a plurality of request packets and sending a plurality of response packets through the security persistence connection.

26. The system of claim 24 wherein the an agent threads manager has a plurality of agent threads each receiving a plurality of sequencing request data packets from the request demultiplexer, analyzing and decoding the sequencing request data packets as a request, mapping the request to a web server, forwarding the request to the web server, accepting a response from the web server, coding the response as a plurality of sequencing response data packets, sending the sequencing response data packets to the response multiplexer.

27. The system of claim 24 wherein the request demultiplexer demultiplexes a plurality of request packets so as to support a plurality of simultaneous requests for each web server.

28. The system of claim 24 wherein the response multiplexer multiplexes a plurality of response data packets so as to support a plurality of simultaneous responses for each web server.

29. The system of claim 16 wherein one security persistent connection is established between the host reverse proxy and the remote reverse proxy server. The host reverse proxy listens connection requests and the remote reverse proxy server initials to send a connection request.

30. The system of claim 16 wherein one security persistent connection is established using a Secure Sockets Layer (SSL) direct connection.

31. The system of claim 16 wherein one security persistent connection is established using a SOCKS proxy with Secure Sockets Layer (SSL) connection.

32. The system of claim 16 wherein one security persistent connection is established using a Secure Sockets Layer (SSL) tunnel connection.
